(19) United States
(12) Patent Application Publication
(10) Pub. No.: US 2009/0165146 A1
(43) Pub. Date: Jun. 25, 2009

(54) METHOD FOR MANAGING USER RIGHTS FOR A CODE PROTECTED OBJECT

(75) Inventors: Eduard Wenzlik, Wolfratshausen (DE); Olaf Kisser, Mueden/Aller (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Leicher Projekt GmbH, Kirchheim (DE)

(21) Appl. No.: 12/358,100

(22) Filed: Jan. 22, 2009

Related U.S. Application Data
(63) Continuation of application No. 11/254,870, filed on Oct. 21, 2005.
(60) Provisional application No. 60/669,360, filed on Apr. 8, 2005.
(60) Provisional application No. 60/620,668, filed on Oct. 22, 2004.

(51) Int. Cl. G06F 21/22

(52) U.S. Cl. 726/28

(57) ABSTRACT

The invention relates to a process for managing user rights for a code-protected object (1) such as, for instance, a bank automat in which a code (6) is generated with an object identification number (7) and an authorization time period (8) by a user rights management (5) that is given to an authorized user (9) for an access to the object (1) and that the authorized person (9) enters into a control device (3) wherein the control device (3) examines the code (6) based on the object identification number (11) specified to it in advance and a time (12) determined by the control device (3). In doing do the user (9) must enter the code (6) into the control device (3) only if the time (12) determined by it conforms at least approximately to the authorization time period (8) contained in the code (6). In the presence of a proper code (6), the control device (3) then provides the authorized person (9) access to the object (1).

The present invention relates to a method for managing user rights for a code-protected object pursuant to the generic term of claim 1.

The management of user rights enables at least the granting and the monitoring of rights as also the subsequent release of the object for the purpose of use by the authorized person. Thus it enables a restricted group of persons to exclusively use an object that is managed accordingly. Here, the term ‘protected objects’ refers to security locks, vaults, automated teller machines (ATM), cash recyclers (CR), key automated teller machines, machines, devices and premises, such as for instance hotel rooms, etc. that are secured against access by unauthorized persons. In general the user rights can provide the authorized user the access, admission or other possibilities of use subject to his rights.

In the recent past even greater demands have been made on the process for managing user rights for protected objects. The problem that has crystallized particularly in the management of user rights for the maintenance, care and equipment of automated teller machines (ATM) is that an entire series of various service providers are supposed to gain access to the devices that are also referred to as automated teller machines without adversely affecting the security of the automated teller machines. Usually, apart from bank employees, even the employees of valuables transporting companies (VTC) and customer service companies (CSC) obtain access to the protected objects.

In the past, the user rights management handed out keys for every protected object to the individual users who had to deliver the keys again to the management after completing their access to the objects. Since the employees particularly in the valuables transport industry and security industry usually are in charge of a multitude of protected objects, they often carry along a great number of keys. This proves to be very unwieldy. Furthermore, managing the keys can be a complex affair and last but not least, the keys can get lost together causing the associated safety risks.

An alternative is present in the form of numerical locks and also electronically secured code locks in which the person authorized to the access receives only a string of numbers or characters by the management that provides him access to the secured object. The persons authorized to the access usually transmit the code via an input device to a control device of the object. The control device compares this entered code (input code) with a default code that is given to it (default code). If both the codes are identical, the control device provides access to the object, for instance by unlocking a lock. The advantage of this solution is that the management comprising the generation, output and handling of codes is usually less complex than that of keys.

However, the problem in this known solution is that the storage space in the code lock that is required for the storage of default codes is limited and only a fixed and limited number of codes for each code lock can be issued and managed. Therefore, in case of an increasing number of persons authorized to the access, the codes that are individually assigned to each code lock are usually handed out to a multitude of persons. The fact that these can often amount to several dozens of persons reduces the object security severely. This problem intensifies further in part if the service companies and valuables transport companies have a high rate of staff fluctuation. Then it is often very difficult to determine who is or was actually in possession of a code for a specific code lock.

In order to solve this problem, processes were developed for managing user rights in which the codes issued by the management become invalid after a certain period of time or can be changed by the management by data transmission in the code lock. In the case of these alterable or aging codes, there is no storage risk, i.e. the loss of a code is no longer an immediate security risk at least after the loss is known or after a certain period of time. However, it is necessary, to provide the code lock with a data transmission device such as, for instance, a data line or a radio contact for the purpose of replacing a canceled code with a new one. Naturally, data transmission devices in turn have new security risks and are very complex and cost-intensive to maintain. In addition, already prevailing code locks often cannot be provided with a data transmission device. This often makes it too expensive to change the user rights management to a process communicating by a data transmission device particularly in case of a large number of code-protected objects to be managed, such as for instance, in case of area-wide networks of automated teller machines of a bank.

For the purpose of solving this problem in the management of user rights for automated teller machines, the valuables transport companies and service companies in the USA are provided with transponders that act as electronic keys and lock the electronically secured locks with changing codes. The already known disadvantages of conventional keys are naturally also present in this system.

Therefore the present invention faces the task of specifying a simple process for managing user rights of code-protected objects in which an unlimited number of codes can be issued without having to connect the control device of the code-protected object via a data transmission device to the user rights management.

This task is solved by the process for managing user rights pursuant to claim 1. Advantageous embodiments and configurations are described in the dependent claims.

In the process pursuant to the present invention, a user rights management generates a code that contains object identification and an authorization time period. This code is then conveyed to a user authorized for access to the object. In order to gain access to the secured object, the user enters this code into the control device. The control device examines the entered code on the basis of an object identification specified to it and a period of time determined by it. Therefore it is necessary for the user to enter the code into the control device if the time period determined by it conforms to the authorization time period contained in the code.

In doing so, the user rights management can convey the code to the authorized user in encrypted or unencrypted form. An encrypted code further increases the security of the process. Usually the authorized person enters the code into the control device via an input device such as, for instance, a keyboard or a card reader, wherein the input device can be arranged as an integrated component of the control device or also spatially separated from it.

The object identification contained in the code can consist of an arbitrary character string, a password, an object identification number (object ID), a coding scheme, etc. However, it is important that it must be specified to the control device in an unambiguous and unchangeable form. In doing so, it is immaterial whether the object identification is stored in the control device in an unchangeable form or in a form that is changeable by the user rights management. A particularly advantageous object identification is the unchangeable and individual product number of the respective control device.

An essential characteristic of the process in accordance with the invention is that the control device not only examines the object identification, but instead also the authorization time period contained in the code entered. The control device reads this authorization time period data in the code entered and compares it with a time period determined by it independently. If the time period determined by the control device corresponds to the authorization time period of the code, the control device enables access to the object, for instance by unlocking the locking device of a lock, opening a door or a lock or by swinging a shutter backwards.

The conformity of the authorization time period contained in the code and the authorization time period determined by the control device is ascertained with predetermined accuracy. The control device can determine the conformity of the time period ascertained by it with the authorization time period contained in the code within seconds or it can permit some fuzziness and/or deviation from the target value by requiring an accuracy of conformity to the order of hours or days. The advantage of the latter is that a time frame is easily generated within which the authorized person must enter the code. This is particularly advantageous if, for instance, a deviating entry due to traffic congestion can be anticipated even during the assignment of the code.

The special advantage of this process is that the control device is provided with code that is not known to it previously, which it then examines on the basis of an independent counting unit such as a watch. Thus this process makes it possible to generate endlessly many new codes without having to specify these in advance to the control device. This reduces the memory space required for presetting the codes or identification numbers in the control device and it is thus possible to easily create a centrally managed network of protected objects, such as for instance, bank automats without having to connect all objects with the user rights management by means of data transmission devices. In addition, most bank automats already have time determination devices, which further reduces the expenditure and effort, required for refitting such devices.

In the first embodiment of the process in accordance with the invention, the authorization time period contained in the code is a time span wherein the user has to enter the code into the control device if the time period determined by it lies within the authorization time period contained in the code. Hereby the authorized person has to enter the code only within a certain time frame. The advantages of this process have been already described above.

The authorization time period does not necessarily have to be a clock time. It is rather a measurement for a unit counted at a certain speed. Therefore a process is also possible in which the authorization time period is simply a number that is determined by a constantly running counter. Then at least the user rights management should have a key for converting the counter number into a clock time or the authorized person can have a counter that counts exactly like the counter in the control unit. Using this counter the authorized person can determine when the counter of the control device reaches the predetermined number and he can then enter the code into the control device at the correct point of time.

In an advantageous configuration of the process, the code contains additionally authorized person identification. Because of this, it is possible for the control device to identify an authorized person by examining the authorized person identification contained in the code entered on the basis of an authorized person identification that has been specified to it earlier. Thus the user rights management forms a code with at least three parameters that are independent of one another wherein one parameter is assigned to the authorized person. For this purpose the authorized person identification is usually safely stored in the control device. If the authorized person changes, for instance, the VTC that is responsible for an automat, then this authorized person identification is assigned to the new authorized person. The person who is no longer authorized simply does not receive any new code from the authorized person identification. Thus the person who is no longer authorized only has codes that have no valid authorization time period and therefore also cannot access the object.

The authorized person identification is particularly advantageous if a multitude of persons or companies are supposed to obtain access to the protected object. Thus, for instance, various WTUs (valuables transporting companies), service companies and bank employees can be assigned to one automated teller machine.

In another embodiment of the process in accordance with the invention, the user rights management can grant a user only one limited right of use for the protected object due to which the control device provides the identified user only one limited use that has been specified to it earlier. The different users each receive their own, partly even different access levels for the protected object. In case of an automated teller machine, it makes sense for a VTC employee to obtain only the access to the money compartment while an employee of a service company only obtains access to the components to be serviced by him and not to the money compartment. Therefore it is necessary to give the control device a share level for every user identification.

In another advantageous embodiment of the process in accordance with the invention, the authorization time period comprises a clock time and a date or a clock time or a date. In this process it is then possible to provide both the control device as well as the person authorized for the access with conventional watches wherein it must be ensured that both the watches work synchronously to one another and are adjusted to the same time. This can be the normally applicable local time, such as for instance, the Central European Time in Germany. If only a date is given, then it is possible to give the person authorized for access one whole day of time to access the protected object. In case of the combinations of clock time and date, the authorized person can access the object only on concrete days and at concrete times. If two clock times are specified in the code, then these define a time frame within which the person authorized for access must access the protected object. If the entry is made outside this established time frame, then the code is not valid any more and the control device will not enable access to the protected object.

In an additional advantageous embodiment of the process in accordance with the invention, the authorization time period is determined and examined in the user rights management and in the control device on the basis of two identically working watches wherein the watches run faster or slower than a watch that determines the normal clock time. For instance, in case of watches running twice as fast, it is possible to determine on one day two authorization time periods that are offset by 12 hours if the authorization time period does not contain any concrete date. The advantage of this embodiment is that there is a second access time that can be informed to the authorized person by the user rights management, for instance, if he has missed the first access time on that day.

It is also possible to provide a control device with two authorization time periods whereby the first authorization time period is a clock time that, for instance, is counted faster or slower and the other authorization time period is a date that is determined as usual. This solution makes it even possible to define several authorization time points for the access to the protected object per day on different days.

In another advantageous embodiment of the process in accordance with the invention, the access of an authorized person is stored together with the access time for the purpose of documenting the access. This is advantageous particularly for underwriting reasons since this method records data such as who actually had access to the protected object.

In another embodiment of the process the user rights management can obtain a return confirmation by data transmission about the completed access to the protected object. The advantage here too is that an access is documented. It is then also possible to save the access externally. Such a process can further be improved advantageously such that the user rights management can change the code parameters by data transmission and/or can specify them to the control device again. Thus it is possible for instance, to change the object identification or to provide an old object identification wherein after an elapsed period of time, a new object identification is entered and specified in advance to the control device. Then it is also possible via data transmission for instance, in case of electric watches, to switch the watches of the control device such that they run synchronous to the watch of the user rights management or the watch of the user.

The process is also used advantageously in order to control a locking element such as for instance a lock of a bank automat by means of a control device.

In another embodiment the user rights are managed centrally. This can take place for instance in a call center of a bank wherein this centrally managed process has the advantages of the bank-type safety devices and safety frameworks. Another advantage of a central user rights management is that the bank can exercise a timely check on the activity of the authorized person.

It is also possible to use the process to manage the user rights of the protected objects locally. In doing so, for instance, a VTC can manage its user level of a money automat assigned to it with the help of software that is licensed by the bank and a service company can manage the authorization and access levels of its employees that are assigned to it. The advantage of this procedure is that the authorized persons can plan the access to the automat and even deduct amount within their user and access levels and/or laws independent of the specifications of the bank.

In another advantageous embodiment of the procedure, the user rights are granted allowing for an access time planning by the authorized person. As has been described already, it is extremely important that the respective authorized person enters the code at the protected object at a certain point of time. Since the service companies or the VTCs usually handle a multitude of protected objects in a day, it is advantageous if the user rights are granted and the access code for the protected object is assigned allowing for the access time planning and/or the route plan of the employee of the companies. Thus the user rights management can be networked to the route planning of the authorized person and authorization codes can be generated on the basis of his route planning.

Alternatively the user rights management can first grant a code only if the authorized person requires the access option, for instance if he is confronted with the protected object. The authorized person can then simply go to the protected object whenever he wants to. If he is on site, he reports to the user rights management and informs it about the protected object that he is confronted with. The user rights management then sends him a code that is valid for the corresponding object, for instance, by SMS that he must provide to the control device immediately after reception. It is therefore important in this embodiment that the user rights management has a watch that runs in harmony with the watch of the protected object. The advantage of this embodiment is the great flexibility of the user to plan his access time.

The invention is described in the following pages in more detail on the basis of a drawing of which the following figures illustrate schematically:

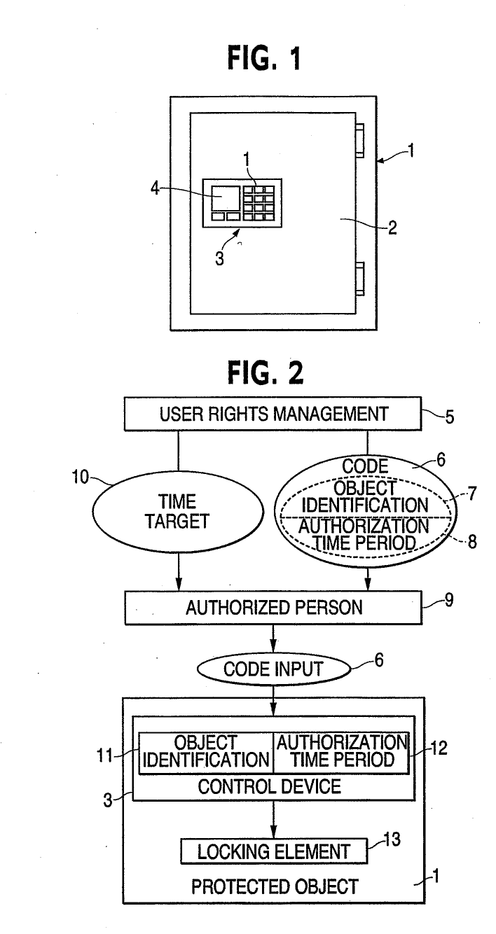

FIG. 1 a view of the rear side of a bank automat;

FIG. 2 a block diagram for a first embodiment of the process pursuant to the invention;

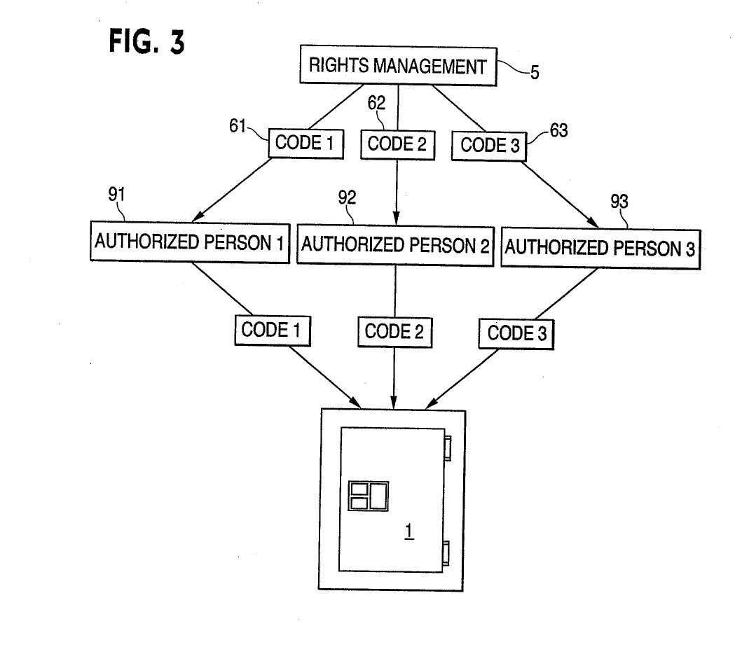

FIG. 3 a block diagram for a second embodiment of the process pursuant to the invention;

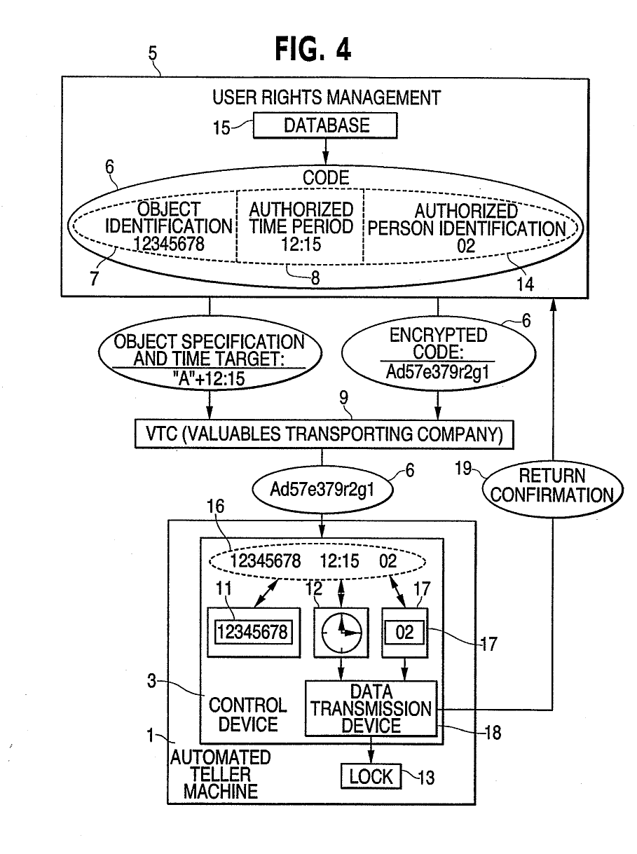

FIG. 4 a block diagram for a third embodiment of the process pursuant to the invention;

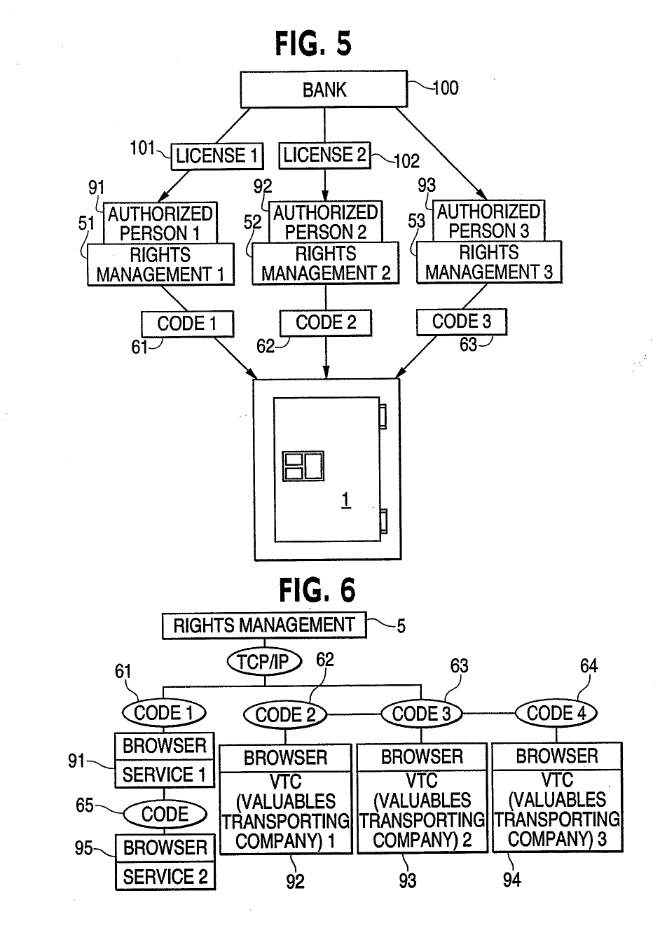

FIG. 5 a block diagram for a fourth embodiment of the process pursuant to the invention;

FIG. 6 a block diagram for a fifth embodiment of the process pursuant to the invention.

FIG. 1 illustrates schematically a code-protected object 1 whose user rights are managed using the process pursuant to the invention. In this first embodiment, the code-protected object 1 is a bank automat that serves for completing conventional functional procedures or transactions such as, for instance, withdrawing or depositing cash, enquiries regarding account balances, printing account statements, executing bank transfer, etc. FIG. 1 illustrates the rear side of an automat with a door 2 that has a control device 3. The control device 3 has on its outer side an input device 4 that comprises a keypad 4a and a display 4b.

FIG. 2 illustrates a first embodiment of the process for managing user rights of the bank automat 1 illustrated in FIG. 1. Pursuant to the invention, the user rights management 5 generates a code 6 that contains object identification 7 and an authorization time period 8. The code 6 is given to the authorized person 9 together with a time target 10. The time target 10 specifies when the authorized person 9 is supposed to have access to the protected object 1 known to him. In doing so, the code 6 and the time target 10 can be conveyed in the usual manner for instance in paper form by mail, by E-mail, by radio, by telephone or even by SMS.

At the predetermined time 10 the authorized person 9 must enter the code 6 in the control device 3 of the protected object. During inspection, the control device 3 compares the part 7 of the entered code 6 that contains the object identification with object identification 11 specified to it in advance. Furthermore, the control device 3 examines the authorization time period 8 contained in the entered code 6 with a time 12 determined by the control device.

The control device 3 has a conventional storage medium in which the object identification 11 can be stored and a time component or a watch for determining the authorization time period 12. If the entered object identification 7 conforms to the predetermined object identification 11 and if the entered clock time 8 conforms to the time 12 determined by the control device, then the control device 3 controls the locking element 13 of the door 2 of the bank automat 1 such that the door 2 can be opened.

As can be seen in this example, it is extremely important that the authorized person 9 enters the code 6 accurately only if the time 12 determined in the control device 3 conforms to the authorization time period 8. In order to achieve an as good agreement as possible between the point of time of the code entry and the time 12 determined by the control device, it is conceivable for instance, that the clock time 12 determined by the control device 3 is specified on a display 4b on the control device 3. Then the authorized person 9 can wait until the exact time 12 is displayed that conforms to his time target 10 predetermined by the user rights management 5 and can then enter his code 6. Alternatively the watch of the control device 3 can determine the time in a hidden, thus not visible, manner. However in that case the authorized person 9 must have a watch that determines the time exactly in line with the watch of the control device 3. He then can enter the code 6 together with the time target 10 obtained from the user rights management 5.

In this example, while examining the authorization time period 8, the control device 3 allows for a certain time transgression and time shortfall and/or tolerance time. Thus during the examination of the authorization time period 8, a time frame of an hour is accepted as tolerance time. It is also possible to define the code parameter of authorization time period 8 as a time frame with a start time and an end time. Then the control device would merely have to examine whether the time 12 determined by it lies within or even outside the authorization time period 8 and could accordingly allow or prevent access.

FIG. 3 illustrates a second embodiment of the process in which three different codes 61, 62 and 63 are given by a central rights management 5. These are forwarded to three different authorized persons for instance, money transport companies 91, 92, 93 such that three different authorized persons have access to the automated teller machine in that each person enters his own individual code.

In FIG. 4 a third embodiment of the process pursuant to the invention for managing user rights is illustrated in which in the rights management 5 a code 6 is created out of a database 15. The code 6 contains an object identification number 7, an authorization time period 8 and authorized person identification 14 and is encrypted after its creation in the user rights management and is given to the authorized person 9 who in this example is a valuables transporting company (VTC). Together with the code 6, the authorized person 9 receives a specification 10 as to when he must access the protected object ‘A’. In this example, the object identification number reads 12345678, the authorization time period 12.15 and the authorized person identification 02. The authorized person 9 enters the encrypted code 6 into the control device 3 of the protected object ‘A’ that is an Automated Teller Machine in this example.

In this embodiment, the code 6 has ten digits wherein it is possible to have codes that have either a greater or a lesser number of characters. The control device 3 decrypts the entered code 16 and examines the parameters of object identification, authorization time period and authorization identification that are contained in the code 16.

The object identification 11 specified to the control device 3 is 12345678 and therefore agrees with the entered object identification number. The clock time at which the code 6 was entered into the control device is determined by the control device 3 as 12.15 and therefore also conforms to the authorization time period. As a last parameter, the authorized person identification of the entered code 16 is compared on the basis of an authorized person identification 17 specified to the control device in advance. Also the authorized person identification entered conforms to the authorized person identification 17 specified to the control device in advance. All three code parameters are correct and the control device 3 opens the lock 13 of the automated teller machine 1.

At the same time the control device 3 conveys to the user rights management 5 a return confirmation 19 that the authorized person 9 had access to the automated teller machine 1 at 12.15. Thus it is possible for the user rights management, to determine online, for instance via a leased line, which authorized person had access to the protected automated teller machine 1. In doing so the data transmission device can also be a memory that is read out only with a certain time delay, for instance by a service company employee.

FIG. 5 also illustrates in a block diagram how the process pursuant to the invention can run in a local organizational structure. In this embodiment, a bank 100, as illustrated here, gives two licenses 101, 102 to two authorized persons 91 and 92. They can operate a rights management 51 and a rights management 52 using these licenses 101, 102. In doing so, the rights management 51 gives a code 61 and the rights management gives a code 62 wherein the codes are constantly varying and unlimited with regard to their authorization time period, but the object identification and the authorized person identification are firmly specified. Thus code 61 contains the authorized identification of the authorized person 91 and the specific object identification for the automated teller machine 1. The codes 62 created by the rights management 52 also contain basically the object identification for the automated teller machine 1, but basically the authorized identification of the authorized person 92 and constantly changing authorization time periods. Thus the two codes 61 and 62 generated by the rights management 91 and the rights management 92 constantly differ from one another.

In this embodiment, the authorized person 93 is a bank employee who, for instance has in a branch office, a rights management 53, for instance in the form of a software running on a conventional computer. Since he is the employee of the bank 100 he requires no license for his rights management 93. The rights management 93 in turn creates a code 53 in the manner already mentioned above wherein here the authorized person identification 93 is added. In this embodiment, it is therefore possible for the different authorized person identifications to open different access levels in the automated teller machine 1. Thus code 93 can open all locks of the automated teller machine 1 while code 91 only enables access to the money compartment and code 92 enables access only to the money counting machine in the money compartment.

FIG. 6 is a schematic illustration of the organizational structure that illustrates the authorized persons connected to the rights management. Here the rights management 5 conveys by TCP/IP a code 61 to a service agency 91 which the service agency can receive by means of a conventional browser. Service agency 91 is thus a nationwide operating service center. The nationwide operating service center 91 also conveys the code via TCP/IP to a service employee 95 and the concrete assignment for the maintenance of an automated teller machine 1. Three valuables transporting companies 92, 93 94 can also be seen on the other side. All three obtain directly a code 62, 63 64 via TCP/IP for the rights management.

1. A method for managing user rights for a code-protected object, comprising:
generating a code is generated with an object identification number by a user rights management that is given to an authorized user for access to the object; and
entering by an authorized person enters the code into a control device, wherein the control device examines the code on the basis of the object identification number given to it and enables access of the authorized person to the object in the presence of a proper code, and wherein the code generated by the user rights management also contains an authorization time period such that the control device examines the authorization time period contained in the entered code based on a time determined by the control device wherein the user must give the code to the control device only if the time determined by it conforms to the authorization time period contained in the code.

2. The method of claim 1, wherein the authorization time period contained in the code is a time span wherein the user must give the code to the control device only if the time determined by it lies within the authorization time period contained in the code.

3. The method of claim 1, wherein the code additionally contains an authorized person identification and that the control device identifies an authorized person by examining the authorized person identification contained in the entered code on the basis of an authorized person identification specified to it earlier.

4. The method of claim 3, wherein the user rights management grants to the user only one limited right of use for the protected object due to which the control device enables the identified user only one limited use specified to it in advance.

5. The method of claim 1, wherein the authorization time period comprises a clock time and/or a date.

6. The method of claim 1, wherein the authorization time period is determined and examined in the user rights management and in the control device on the basis of two identically adjusted and identically running watches, wherein the watches run faster or slower than a watch determining the normal clock time.

7. The method of claim 1, wherein the access of an authorized person is stored together with the access time for the purpose of documenting the access.

8. The method of claim 1, wherein the user rights management obtains by data transmission one return confirmation about a completed access to the protected object.

9. The method of claim 1, wherein the user rights management can change the code parameters to be examined and/or specify them again to the control device by data transmission.

10. The method of claim 1, wherein the control device controls a locking device of a bank automat.

11. The method of claim 1, wherein the user rights are managed centrally.

12. The method of claim 1, wherein the user rights are managed locally.

13. The method of claim 1, wherein the user rights are granted allowing for an access time planning of the authorized person.
